(19) United States
(12) Patent Application Publication
(10) Pub. No.: US 2003/0078786 A1
(43) Pub. Date: Apr. 24, 2003

(54) Method and system for a virtual physical fitness service

(76) Inventor: Judith E. Ulrey, Corona Del Mar, CA (US)

Correspondence Address: LEVIN & HAWES, LLP, Suite 13, 384 Forest Ave., Laguna Beach, CA, 92652, US

(21) Appl. No.: 09/759,648

(22) Filed: Jan. 12, 2001

Related U.S. Application Data
(60) Provisional application No. 60/176,198, filed on Jan. 14, 2000.

(51) Int. Cl. G06F 17/60

(52) U.S. Cl. 705/1

(57) ABSTRACT

A virtual physical fitness club is provided by which an individual can obtain instruction from animated cartoon like physical fitness trainers. The system in a preferred embodiment presents the instruction by the cartoon like characters over a computer system attached to the internet or some other type of visual broadcast apparatus. A person while at their computer enters the virtual physical fitness club located on a remote server and moves about the site as if they were at a physical fitness club where they can access trainers in different locations or rooms who will provide instruction in various aerobic exercises, strength building exercises and the like. Each of the instructors have their own unique personality to provide a more personalized experience and the exercises presented are ones that an individual can do at their desk or similar location without the need for special equipment.

The Application claims the benefit under 35 USC 119 (e) of previously file provisional application No. 60/176,198 filed Jan. 14, 2000.

A portion of the disclosure of this patent document contains material that is subject to copyright protection. The copyright owner has no objection to facsimile reproduction by any one of the patent disclosure, as it appears in the Patent and Trademark Office patent files or records, but otherwise reserves all copyright rights whatsoever.

### FIELD OF THE INVENTION

The present invention relates to providing services and products over a networked computer system. More particularly it relates to a system and method for providing physical fitness, health and related services over a networked computer system.

### BACKGROUND OF THE INVENTION

The pace of life in general and work in particular has increased tremendously over the last few decades. Although the type of work that most people do has become more sedentary, often working in an office at a computer it has also become much more stress. This lack of exercise and increase in stressfulness has resulted a dramatic increase in compensation claims for stress related afflictions. The cost to companies, the government and the economy in general has been substantial. Many companies have taken the initiative to deal with these problems by instituting wellness programs. However, these programs tend to be complicated, time consuming and expensive. Thus, only large corporations with substantial profits generally use them.

Individuals have also taken steps to achieve personal health and physical well being by developing their there own programs for obtaining the proper exercise and nutrition two of the primary means of dealing with and preventing physical and mental disabilities caused by the increasing stressful and sedentary aspects of modern life. Among the many solutions are joining a health club, hiring a personal fitness trainer, reading books and related materials to develop their own program to maintain physical and emotional health in the face of the onslaught of stress and related problems.

All of the current solutions for the problems caused by stress and other problems of modern life are expensive, time consuming or to complicated for the average person in their daily life to properly implement. There have been attempts to provide a solution over networked computers in particular the internet. At present, there are any number of sits that offer information on nutrition and diet. There are also sites on the internet that offer information on exercise programs and other aspects of helping an individual achieve physical fitness. However, none offer a comprehensive program and easily utilized program that integrates all of the basic essentials into a convenient and easily used package that is relatively inexpensive in comparison to what is currently available. A system or method that is equally available to a large corporation or an individual and one that has the flexibility of being adapted to use by large and small organizations to help their members or employees lead healthy and productive lives.

### SUMMARY

The present invention is designed to provide an inexpensive system and method that can allow an organization to help its members or employees to achieve physical and mental health and thereby help the organization achieve its quality and productivity goals. It is an objective of the present invention to provide a system and method that can be also be adapted to the needs of individual users. It is a further object of the present invention to provide a system and method that allows the individual to tailor its use to his or her own life style and work environment. A system and method that adapts the power of the internet to provide effective, inexpensive and user friendly means for one to become and remain physically and mentally fit.

The invention accomplishes these and other objectives by providing a virtual physical fitness site on a computer system that includes: a) a site on a computer system accessible by individuals with access to the computer system, said site having the appearance of a physical fitness club; b) a database of viewable animated characters at the site that upon appropriate activation demonstrate to a person accessing the site a specific exercise; c) the site is interconnected to a network or networks of a plurality of interconnected computers, the network in the preferred embodiment being the internet; and d) each person accessing the site and record is maintained of the exercises completed by each individual using the site.

In another aspect of the invention it provides a method for providing physical fitness services on a computer system that includes the steps of: a) providing an accessible site on a computer system that has the appearance of a physical fitness club; b) providing at the site animated characters to demonstrate physical exercises upon activation by a person visiting the site from another location on the computer system; c) tracking the persons usage of the site and providing periodic reports on that persons usage of the site; d) providing nutritional information at the site; e) providing animated characters demonstrating exercises comprises demonstrating exercises that can be performed by a person while at a desk in an office; f) providing in one version of a preferred embodiment animated characters that may be cartoon like animated characters.

### BRIEF DESCRIPTION OF THE DRAWINGS

The invention will be better understood by an examination of the following description, together with the accompanying drawings, in which:

FIG. 1 flow chart and schematic diagram of a preferred embodiment;

FIG. 1A provides another schematic diagram of a preferred embodiment;

FIG. 2 pre login front desk web page of a preferred embodiment;

FIG. 3 post login front desk web page of a preferred embodiment;

FIG. 4 a web page with a site map of the web site of a preferred embodiment;

FIG. 5 a web page of a stretching salon of a preferred embodiment;

FIG. 6. a second web page of the stretching salon with a character demonstrating another stretching exercise;

FIG. 7 a web page congratulating a member on completing an exercise routine;

FIG. 8 a web page of a strength fitness salon;

FIG. 9 a web page of the cardio fitness salon;

FIG. 10 a web page with the exercise records of a club member;

FIG. 11 a web page that provides nutritional information; and

FIG. 12 a web page that provides a search function to search for specific information at the web site of a preferred embodiment of the present invention.

### DETAILED DESCRIPTION OF THE PREFERRED EMBODIMENT

The present invention provides a virtual on-line health club that in its preferred embodiment can be accessed over the Internet; although, it has the capability of operating over a local area computer network. The invention was developed to mirror the traditional health club model by allowing individuals and or corporate employees to access it from their desk or computer workstations during their workday breaks or at any other times they find it convenient and desirable.

The virtual health club concept is unique because: a) it models a traditional health club as a virtual reality health club accessible at computer or internet site; b) it provides exercise classes (stretching and strength training) led or demonstrated by animated characters, in the preferred embodiment they are animated cartoon trainers; c) it varies the exercise classes by changing them on a periodic basis, in the preferred embodiment daily, therefore providing an on-going exercise program for members that is both interesting and effective; d) the site tracks participation of those using the site; e) the site provides a comprehensive wellness routine, that includes exercise classes, nutrition information, incentive contests, safety training, as well as coaching of corporate wellness coordinators/risk managers on internal promotions and complementary programming to reinforce the effect and purpose of the invention to improve employee health moral and related factors; f) the site, through the Cardio Room in the preferred embodiment, enables members to record aerobic or other exercises that employee has done outside the office or away from their computer for tracking purposes; and g) the site provides quarterly utilization reports to members of the exercises they have completed.

The site is made up of a series of rooms, web pages, that have both member bulletin boards and information boards, providing current news in that area. Members can contribute their health ideas on the bulletin boards, prompted by a question of the week or some other similar prompt, i.e. “What's your favorite low-fat snack?” etc. Members can also find current news and information on the information boards, such as how to register for special programs, contests or the like, i.e., “The Race for the Cure” in their area in the Cardio Room. Each room also will eventually have a corporate sponsor or sponsors, i.e. sports ware and apparel companies, cosmetic companies, exercise equipment companies, fitness magazines, etc.

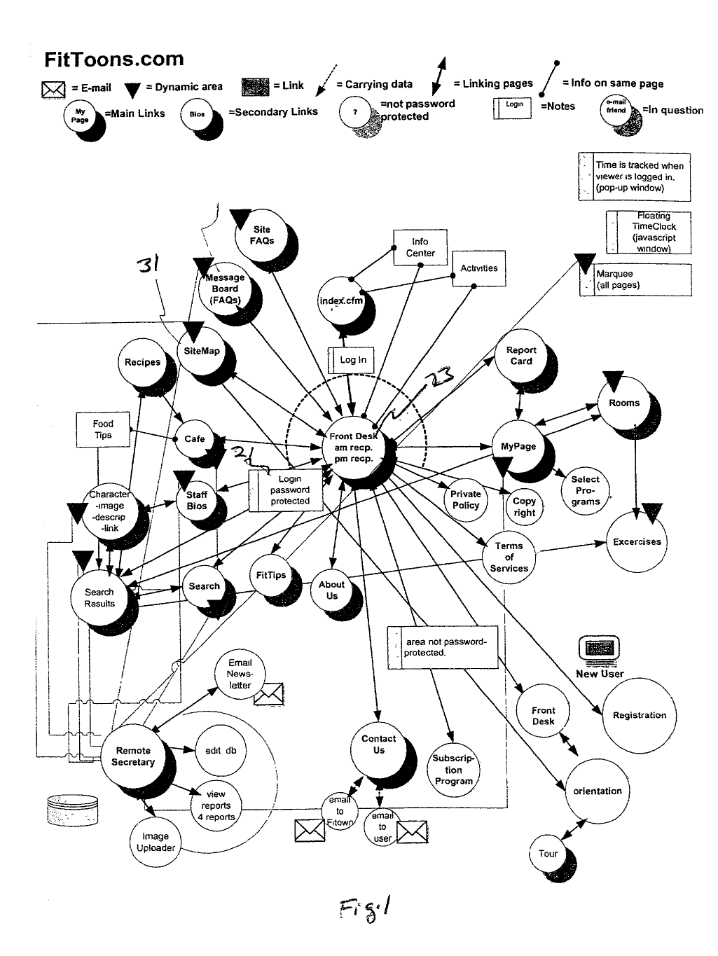

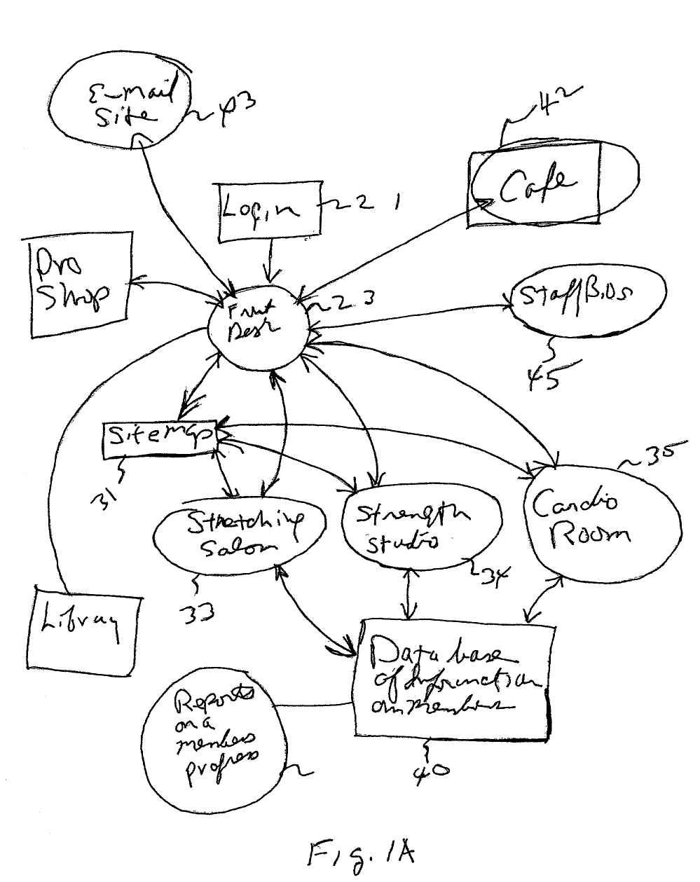

The attached flow chart and schematic diagram, FIG. 1, provides the overall functional structure of the club. Once members have logged in at the front desk 21 they can go anywhere they choose on the site. In the preferred embodiment the site would be on a server accessible from any computer connected to the internet. FIG. 1A provides another schematic diagram view of the site. The site includes not only the front desk and site map but also: a stretching salon 33, a strength studio 34, a cardio room 35, a database of members activities 40, reports on members progress 42, a café 42, staff bios 45 to give the animated characters an appealing personality, email area 46, pros-hop 47 and library of useful information 48. The functions of these features will be elaborated on below.

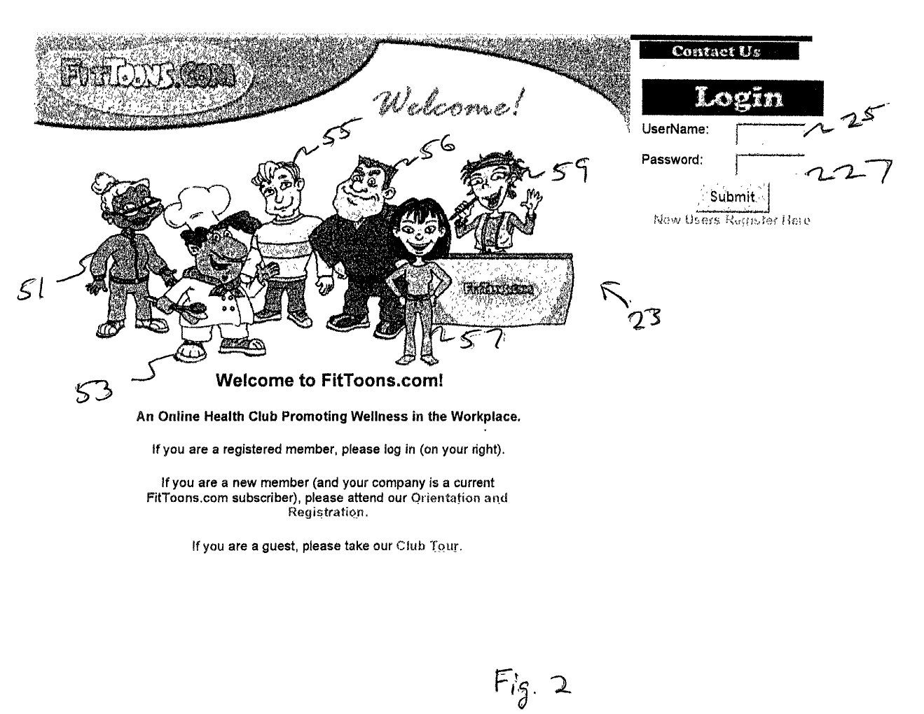

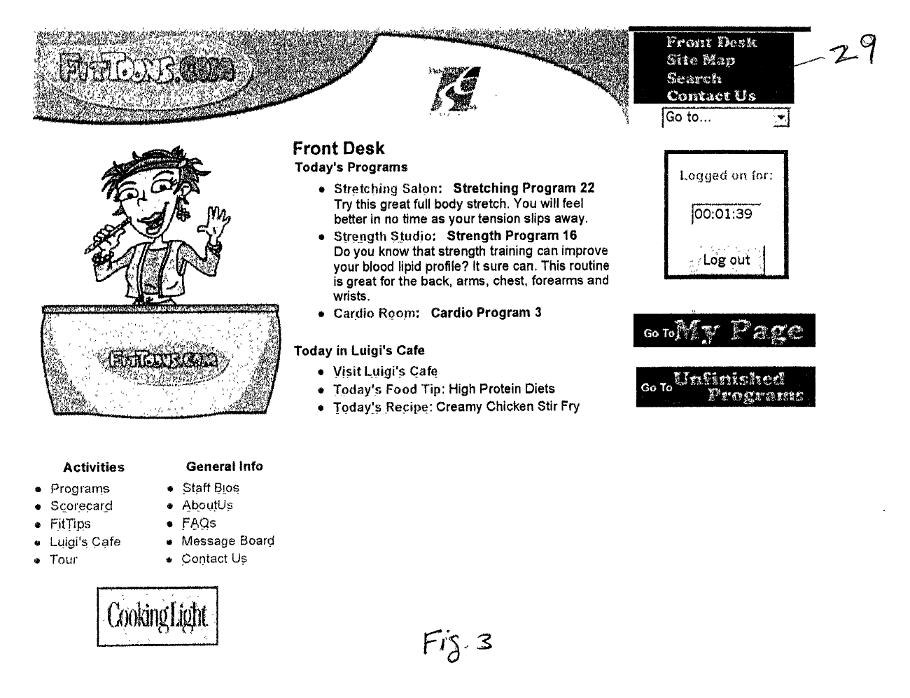

Front Desk (Home Page) (FIGS. 2 and 3) The front pages, both the pre-login page, FIG. 2, and the post-login page, FIG. 3 represent the Club Front Desk 23. As with the traditional health club, only members can enter beyond this point by logging in 21. The Front Desk pages, FIGS. 2 and 3, provide general information regarding the club, joining etc. In the preferred embodiment both individuals and organizations, such as corporations can join the club. When an individual joins they are assigned a user name 25 and pass word 27. When a corporation joins, it can be assigned a company pass code. Once the company informs its employees of this code (which can be provided via email provided by the site) each employee can then register under that code and choose their own User Name 25 and Password 27. After logging in at the first front desk on the prelo-gin page FIG. 2 the user is then presented with a post login page the web page similar to FIG. 3.

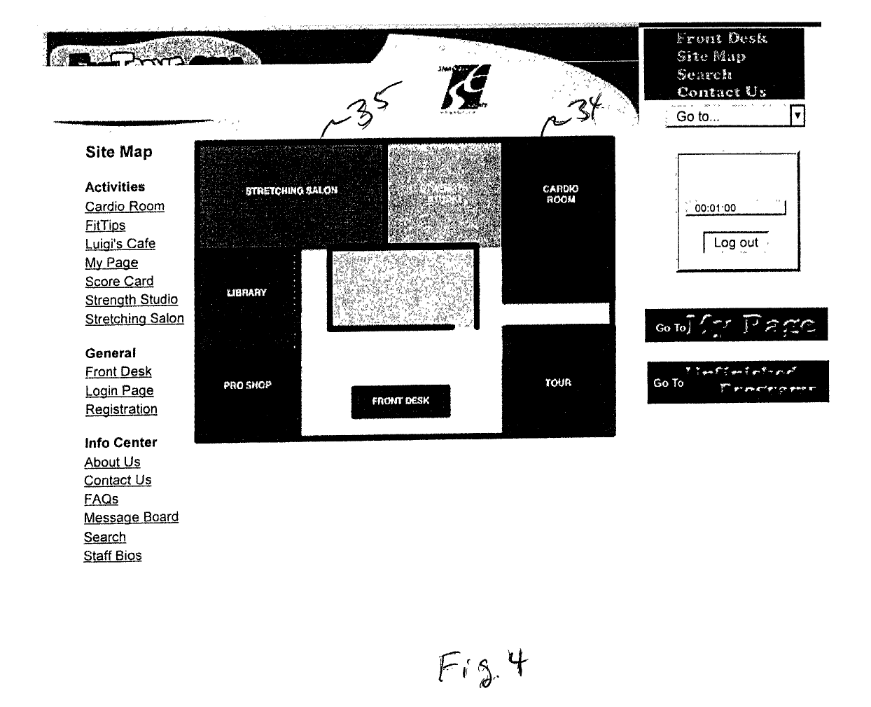

Site Map—Club Floor plan: (FIG. 4) By clicking on the word site map 29 (words in italics indicate the words or symbol on the Figs that result in action, i.e. movement to another web page or activation of a function when clicked on by a person with a pointing device such as a mouse or track ball or by alternatively using the keyboard or some similar device) the club member is taken to site map FIG. 4 or 31 on FIG. 1. The site map (FIG. 4) illustrates all the Club options. It is designed to emulate a health club floor plan. Members simply click on the rooms of interest and be taken to that room. Such as clicking on cardio room the member is taken to the cardio room, clicking on stretching salon 35 the member is taken to that site etc.

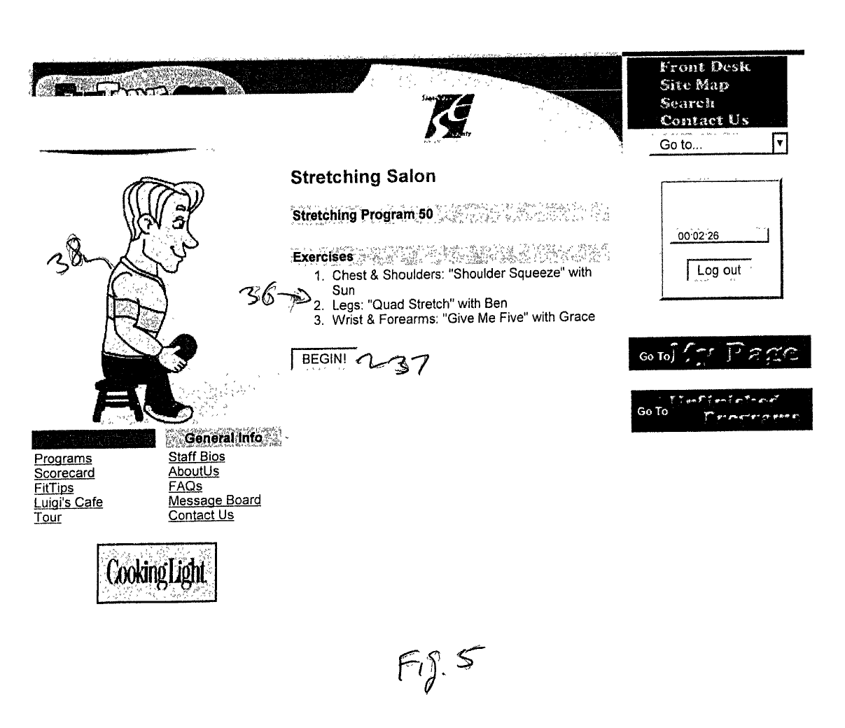

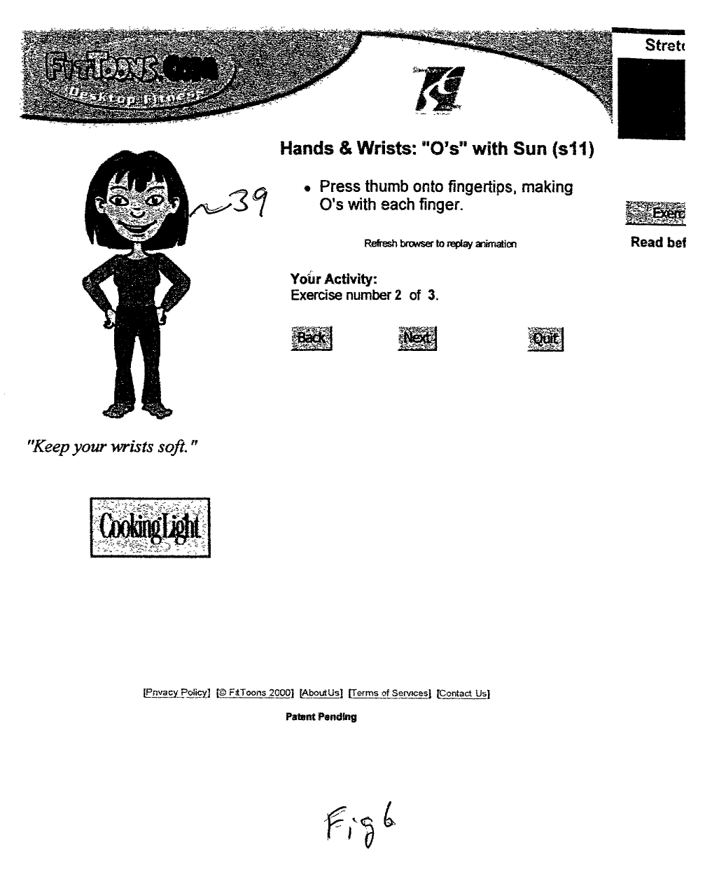

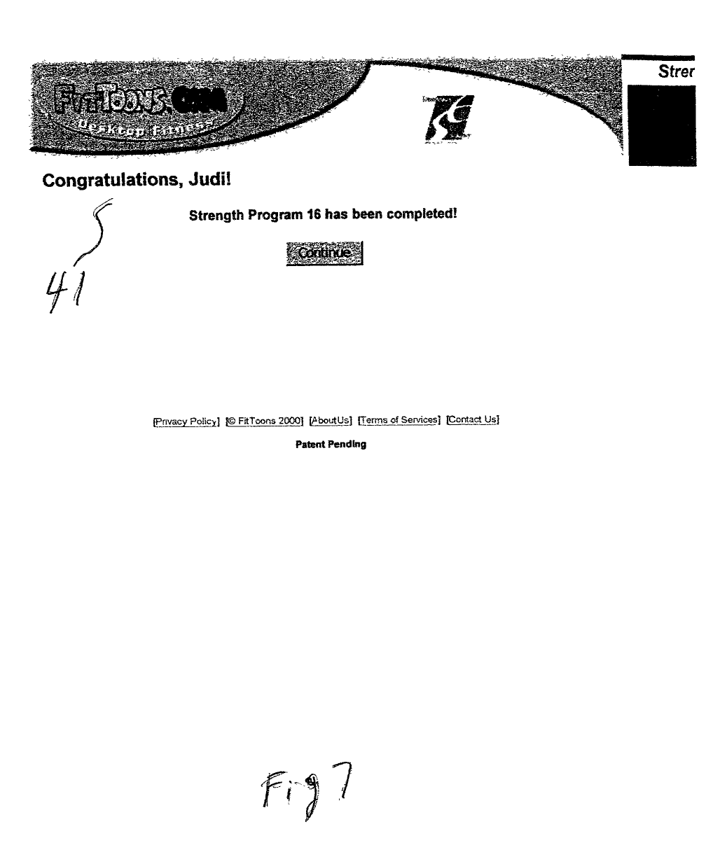

The Stretching Salon: (FIG. 5) is the site members can access for their daily 3-minute stretch classes or other similar types of classes. In the preferred embodiment, all stretches presented are to be done at the members desk, or wherever a person is with his/her computer. In the preferred embodiment the first page of the Stretching Salon is a marquis page (FIG. 5), listing the three stretches of the day 36, and upon clicking Begin 37, the member clicks through the progression of stretches of different stretches presented. Every stretch is demonstrated by one of the animated cartoon trainers 39 such as that depicted in FIG. 5. The member on the screen will actually see the character 38 doing the exercise described at 36. This provides the member with a demonstration by the character 38 of the proper movements to do the exercise. Additional stretching exercises can be demonstrated by the animated characters, for example FIG. 6 has another of the animated characters 39 to demonstrate another stretching exercise. Upon completion of the stretching class, the member is acknowledged for his/her efforts with “Congratulations, Judi!” 41 (FIG. 7), and participation is automatically logged to a database to give the member credit for the exercise.

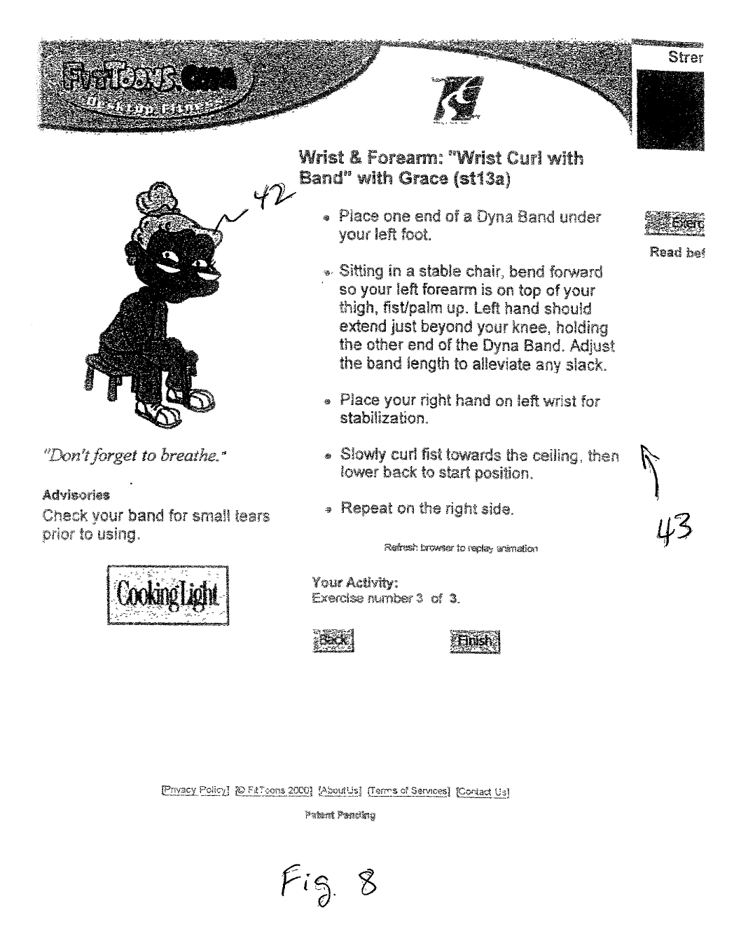

Strength Studio: (FIG. 8) Similar in format to the Stretching Salon in FIGS. 5 and 6, the Strength Studio (FIG. 8) has daily changing 3-minute classes that are demonstrated by three separate animated cartoon characters. In the preferred embodiment these classes are organized by body part. I.e. upper body one day, lower body the next, abs another. The cartoon trainers demonstrate the exercises also are varied. All the exercises, either body or weight exercises, use an elastic band for resistance. Character 42 in FIG. 8 demonstrates the moves to the exercise described next to it 43. A different character would demonstrate other different exercises. Upon completion of the class, the member is again recognized for completing the exercises and a record of that member's completion of the class is automatically logged.

Bulletin Board: The bulletin board not shown will provide timely information of interest to club members. This can vary from information on osteoporosis calcium and related protein needs. The positive effect strength training has on bone development. Additionally, members can post their own success stories (losing body fat, increasing muscle mass viewed via bone density scan) etc.

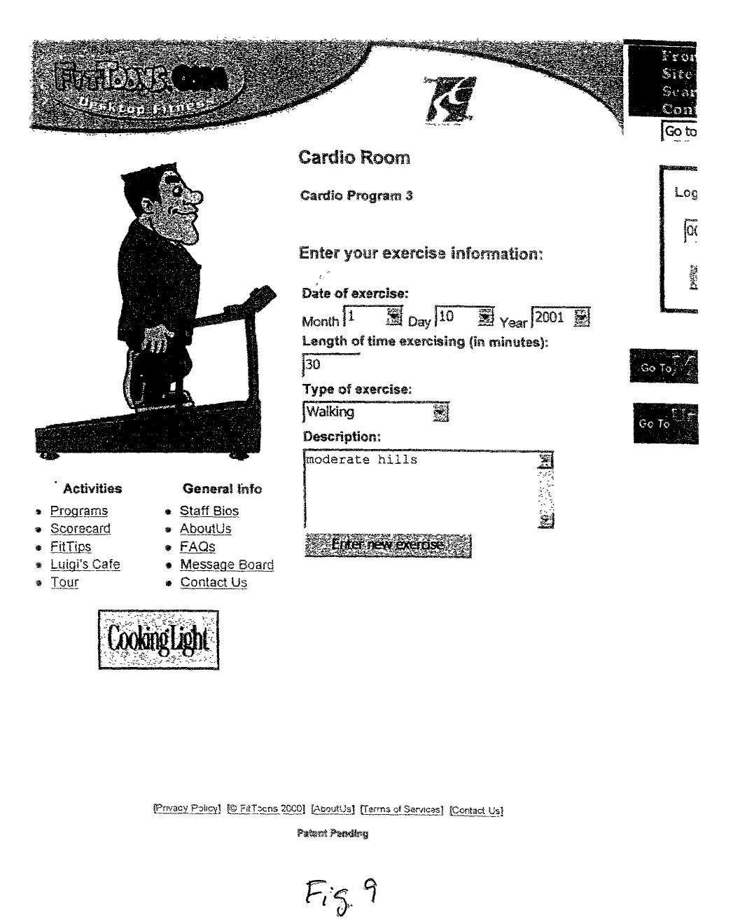

The Cardio Room: (FIG. 9) The Cardio Room (FIG. 9) has three primary purposes: 1) To encourage members to do their aerobic activities; 2) To provide tracking to enable the site to provide incentive prizes to those who are exercising; and 3) gather people with similar interests, i.e. walkers, runners, cycling enthusiasts and provide them with information on common interests.

At this site (FIG. 9) the member can enter information on aerobic exercises done by that member. The information is entered into an interactive database where members can input date, time (in minutes), and type of exercise they performed. Using a search query, then, the site can identify all members who logged enough aerobic exercise minutes to be eligible for an incentive prize.

The Activity Clubs provides information specific to the most popular exercise categories, including walking, running, and cycling. Information on organized events and exercise specific data will be provided Chat rooms related to this and other sites will encourage involvement and regular club participation. They will also help people network with other people of similar interest. The bulletin board will have information on race registration.

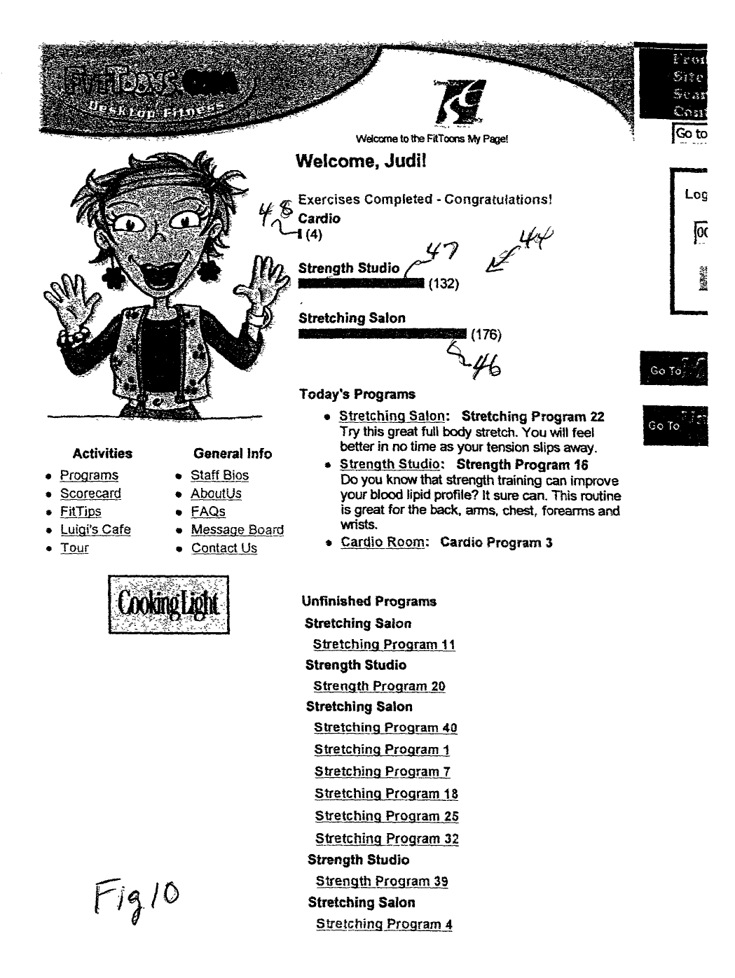

The Scorecard: (FIG. 10) The site will keep track of member activities and documents it in the Scorecard area 44 (FIG. 10). Every stretch 46 and strength training 44 class is accounted for, in addition to any aerobic exercise 48 the member has entered. On this web page depicted in FIG. 10 information unfinished exercise programs will also be provided.

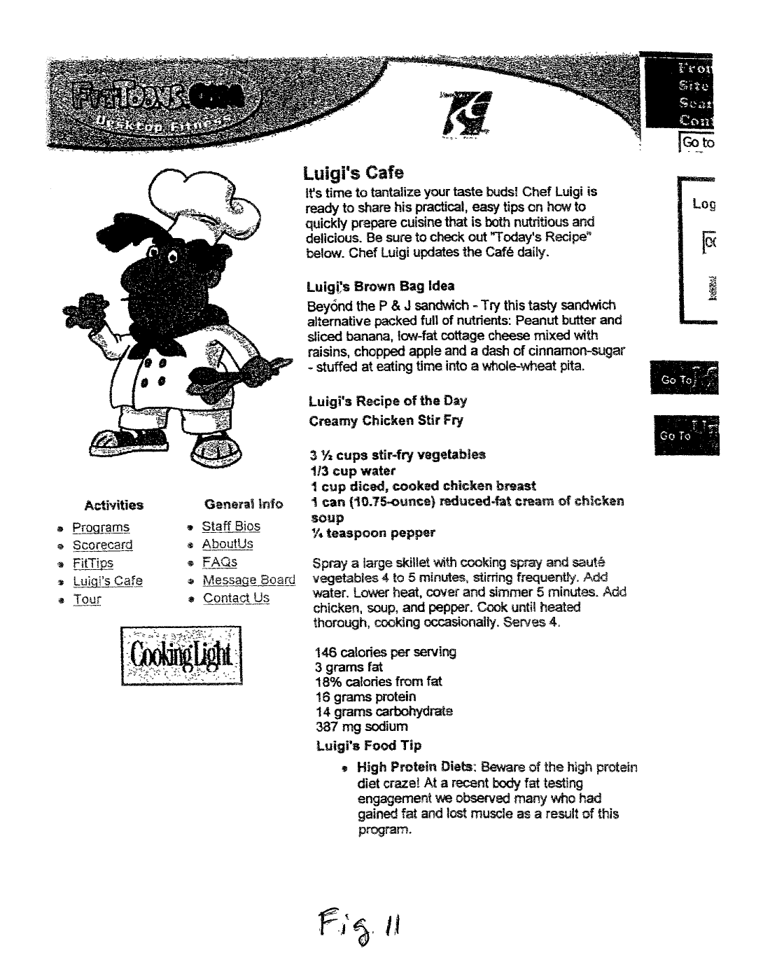

The Nutritional Page: (FIG. 11) The site will also provide nutritional information as exemplified by FIG. 11. Members at this web page (FIG. 11) can find easy, tasty, low-fat recipes. The web page, which will in effect be a bulletin board like page will also provide Brown Bag Lunchbox ideas that will help individuals keep to a good and well balanced diet at work. In the preferred embodiment this web page is purposely text-light to allow people to quickly and easily find and comprehend the information they need. As depicted in FIG. 11 this page

Additional rooms or areas with related web pages that the site will have are 1) an Ergo Room a web page a member can go to receive assistance on setting up his or her office in an ergonomically correct manner. This room will be interactive in that the member will answer a series of questions and tips for setting up the office will be provided. 2) The site will provide a room for quiet contemplation. Since stress in the workplace is a primary concern the quiet room is the place a member can retreat to for relaxing music, poems, relaxation exercises and additional stretches to help the member relax. 3) a children's fitness area that will have web pages of information and activities for the youngsters. Members will appreciate the attention to the kids. In fact there will be a series of these areas at the site organized and with content of interest to children of different age categories. One gradation of theses age categories or age ranges would be infants, 2-4, 5-8, 9-12, 13-15, and 16+. 4) The Coffee Bar will be another relaxation area. It will be sponsored by one of the coffee companies, and will offer jazz music 24-hours/day and similar features. 5) The Pro Shop will advertise and sell products of interest to members and related to their physical fitness and personal health needs. The Pro Shop will sell: a) fitness books we've critiqued and endorsed b) audio tapes c) fitness accessories—fitness ball, pulse monitors, spry bands and d) t-shirts, towels, etc. with images of the site cartoon staff.

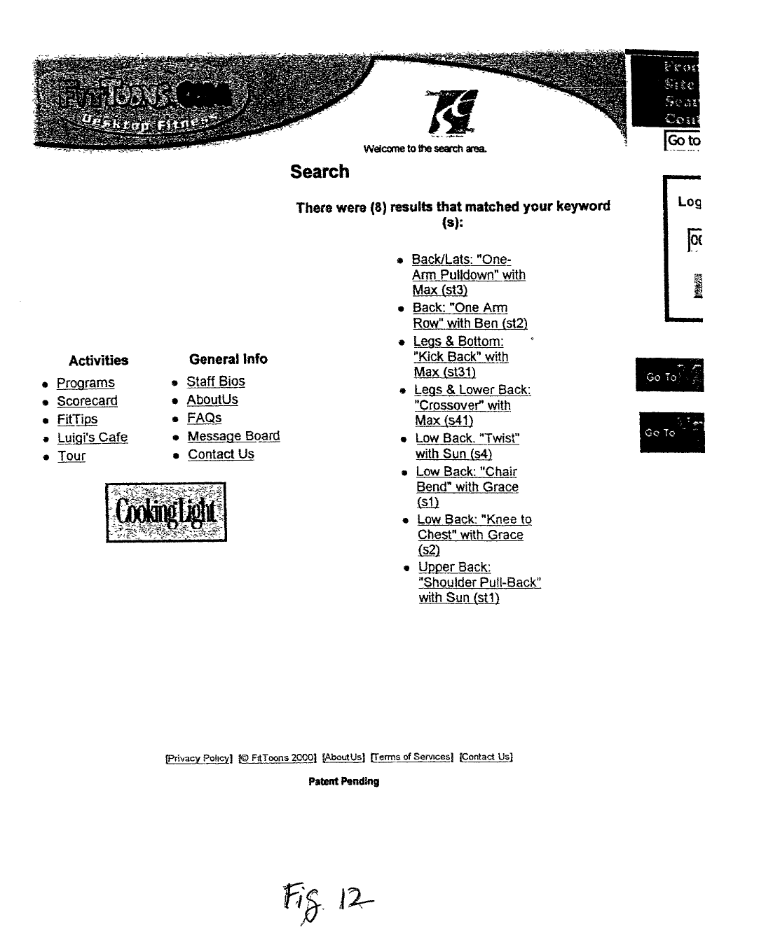

The Search Function (FIG. 12) The search area FIG. 12 enables members to locate exercises by body part, i.e. neck, low back. They also can search for information on other related matters.

Club Staff: One of the most unique features of this invention are the animated cartoon trainers. These cartoons give the site its character and make it fun to access. The characters have been carefully chosen to represent a cross-section of typical Americans. In one version of the preferred embodiment they could be a cross section of corporate America's employee base. A variety of personalities are provided in the preferred embodiment so that members will have a selection of personalities to choose as their favorites from which to choose their favorite. In one version of the preferred embodiment, as depicted in FIG. 2 the characters are Grace 51, Luigi 53, Ben 55, Max 56, Sun 57 and Natasha 59. Each of these characters will have functions similar to an actual staff of a physical fitness club generally that of trainers and instructors. These characters will also be given personalities to make the site more them more appealing and help motivate members to achieve their fitness objectives. In a preferred for instance each of the characters depicted in FIG. 2 could have the following personalities: 1) Max 56—retired, but enjoys the Club atmosphere; x-marine drill sergeant; always has been fit; daily push-ups & sit-ups; smokes cigars on occasion; leads an “Old Goats Workout”. 2) Ben 55—buff, darling, bedroom eyes, quiet, soft spoken, heart throb, 36 yrs. 3) Grace 51—60+ yrs, hair bun in back, “spry, spirited, & spunky”. 4) Sun 57—Asian, soft spoken, lean, centered, spiritual. 5) Stan, the Ego Man—buff, ego maniac. 6) Luigi—the chef extraordinaire, pudgy, jolly, warm, spirited. 7) Natasha—the front desk greeter, young, LA urban, fringe fashion, “out there”.

In one version of the preferred embodiment as note above the invention can be geared towards the needs of organizations such as corporations. Many companies look for ways to enhance the productivity of their employees. One of the ways a corporation can do this is to assist employees to lead healthy and physically fit lives. Thus, many use comprehensive wellness programs run by an outside contractor. The present invention would provide this service and it could be presented in a variety of different ways. For instance, a 10 week program of physical and mental fitness could be based on the popular book As Easy As Your Morning Coffee: Simple Steps to Fitness Success”, by Judi Ulrey. The Components of such a program could include: 1) reading assigned sections of the book each week, and completing related exercises; 2) providing members on the program with recommendations related to the objectives of the program as outlined in the previously mentioned book; 3) encouraging the members to follow a weekly food program related to the course; 4) having the member participating in the program maintain an log, striving for a minimum of four entries per week; 5) having the member participate a scheduled times in one chat room/support group per week with others participating in the program; and 6) sponsor be a buddy to someone else in the program such as with friend or someone selected as part of the program by the site. Service and Support is part of Success.

Communications: Just like any Health Club, the site stays in touch with its members. So the members will regularly receive helpful and informative information written by their Club Staff, including: 1) a brief fitness tip sent daily via email (by request) and 2) a monthly Club newsletter available on-line at the site or sent to the e-mail address of the member.

Corporate Communications: When providing service to a corporation the invention can provide for communication to the corporate members in a variety of ways. The invention can provide monthly utilization reports, including number visits, number unique visitors, and average time spent on line. Additionally, the service can provide for training of a corporate wellness trainer. Each participating company would designate an in-house wellness coordinator who may participate in can participate in a coordinator tips program. This would be information provided by e-mail or other means and will allow that person to administer a successful wellness program, and also help facilitate communication among other coordinators.

The preceding description has depicted the present invention in broad modeling terms. Naturally, part of the system will include a computer software program or programs running on a computer system or on a remote server provided at an accessible internet site. The preceding disclosure does not include any indication of the computer operating code or the relevant source code necessary for functioning software. This is due to the fact that those of ordinary skilled in the art once they have reviewed and understand the particulars of the present invention will be able to compose the necessary software without undue experimentation. In fact those of ordinary skill in the art once having read and understood the particulars of the present invention will appreciate that the software necessary can be written in a variety of different languages and in a variety of different formats. The foregoing description has also included a set of computer screens to help illustrate the process and system of the present invention. However, those skilled in the art will realize, after reviewing the preceding specification that the invention described herein can function with a variety of different computer display screens that can differ significantly from those used for illustrative purposes herein.

While the invention has been particularly shown and described with reference to a preferred embodiment thereof, it will be understood by those skilled in the art that various changes in form and detail may be made to it without departing from the spirit and scope of the invention.

1. A method for providing physical fitness services over a networked computer system comprising: providing on the system animated characters to demonstrate exercises for a person with access to the system so that person can view the animated characters.

2. The method of claim 1 including the further steps of identifying a person viewing the animated characters and recording the viewing of the animated characters by that person.

3. The method of claim 1 including the further step of changing on a periodic basis the exercise routines the animated characters depict.

4. The method of claim 1 including the further step of allowing the person with access to the system to enter information on exercises completed by that person on a periodic basis.

5. The method of claim 4 including the further step of providing a report on the record of information entered on exercises completed by the person.

6. A virtual physical fitness site on a computer system comprising:
a) a site on a computer system accessible by individuals with access to the computer system, said site having the appearance of a physical fitness club; and
b) a database of viewable animated characters at said site that upon appropriate activation demonstrate to a person accessing the site a specific exercise.

7. The site of claim 6 wherein the computer system in a network of a plurality interconnected computers.

8. The site of claim 6 wherein said computer system includes a connection to an internet which site is accessible from computers connected to the internet.

9. The site of claim 6 identifies each person accessing the site and viewing said animated characters.

10. The site of claim 9 wherein said database provides a report on the exercises viewed by a person accessing the site and viewing the animated characters.

11. The site of claim 6 wherein the exercises and animated characters change periodically.

12. The site of claim 6 wherein said animated characters are cartoon like characters.

13. A method for providing physical fitness services on a computer system comprising the steps of:
a) providing an accessible site on a computer system that has the appearance of a physical fitness club; and
b) providing at said site animated characters to demonstrate physical exercises upon activation by a person visiting the site from another location on the computer system.

14. The method of claim 13 including the further steps of identifying the person accessing the site, tracking the persons usage of the site and providing periodic reports on that persons usage of the site.

15. The method of claim 13 including the step of providing nutritional information at the site.

16. The method of claim 13 wherein the step of providing animated characters demonstrating exercises comprises demonstrating exercises that can be performed by a person while at a desk in an office.

17. The method of claim 13 wherein the step of providing animated characters comprises providing cartoon like animated characters.

18. A method for providing virtual physical fitness services on a computer system comprising the steps of:
a) providing access to a site on a computer, said computer being connected to an network of computers and access being obtained from one or more other computers on the network of computers; and
b) providing animated characters at the site to demonstrate exercises to be preformed by a person accessing the site.
